(19) United States
(12) Patent Application Publication
(10) Pub. No.: US 2013/0008320 A1
(43) Pub. Date: Jan. 10, 2013

(54) Cooking Oil Filtration System

(76) Inventor: Michael Christian Kilmer, LaPorte, TX (US)

(21) Appl. No.: 13/341,905

(22) Filed: Dec. 30, 2011

Related U.S. Application Data
(60) Provisional application No. 61/428,739, filed on Dec. 30, 2010.

(51) Int. Cl. A47J 37/12

(52) U.S. Cl. 99/408; 210/167.28

(57) ABSTRACT

A cooking oil filtration system for a cooking apparatus wherein organic contaminants suspended in hot cooking oil are separated and trapped in/on a hollow cylindrical filter made of high temperature food grade and/or FDA approved polymer material as the hot cooking oil is pumped through a filter housing fluidly connected to a cooking oil reservoir. A fryer basket with walls and a bottom constructed of fine wire mesh provide surface filtration of organic contaminants suspended in the hot cooking oil before passing through the filter housing.

### CROSS-REFERENCES TO RELATED APPLICATIONS

This application claims the benefit of U.S. Provisional Application No. 61/428,739 filed Dec. 30, 2010.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO A SEQUENCE LISTING

Not Applicable.

### BACKGROUND OF THE INVENTION

1. Field of the Invention

The present invention generally relates to a system comprising a group of devices for use with a cooking apparatus, including a cooking oil purification or separation means, through which cooking oil is purified or separated and continuously returned and reused by the cooking apparatus.

2. Description of the Related Art

Present filtration systems connected to the cooking apparatus, such as a deep fat fryer or vacuum fryer, typically use either a single or multi-stage purification system to purify the cooking oil. In a typical single stage purification system a filter media is used to remove solids suspended in the cooking oil. As disclosed in U.S. Pat. No. 4,068,571 issued to Cunningham, a predetermined amount of filter media, like cotton fiber, is placed within a filter cavity disposed within a flow of cooking oil. The cotton fiber traps solids and eventually creates a filter bed by which further solids are removed from the cooking oil as it passes through. In the multi-stage system, the typical filter comprises a first stage that removes larger solids suspended in the cooking oil and a second stage that removes smaller solids suspended in the cooking oil. U.S. Pat. No. 3,685,433 issued to Cunningham discloses the use of a paper sheet against the inner surface of a foraminous cylindrical shell filled with copper turnings wherein purification is achieved as the cooking oil moves from the interior of the shell through the copper turnings (first stage) and the paper filter (second stage) to the exterior of the shell. Whether a single or multi-stage filter, the use of free filter media such as copper turnings or cotton fiber without a support structure results in compaction and eventually failure of the purification process.

Other cooking oil purification processes utilize a pre-coat filter. A woven wire cloth typically provides the structure for the buildup of a filter cake. The weave pattern of the wire cloth and the type of filter medium typically determines the effectiveness of the cooking oil purification process. Use of pre-coat wire cloth filter may affect the quality of the cooking oil if the improper wire cloth is used to set up the filter bed. Furthermore, the use of a pre-coat with wire cloth increases the likelihood of contamination of the cooking oil with the filter media.

The purification processes described above tend to result in increased operating costs, mostly due to the labor required to replace the appropriate amount of filter media. Furthermore, these purification process increase the likelihood of cook oil losses due to improper filter preparation/installation. Finally, the likelihood of personal injuries increase when improper filter preparation/installation occurs.

### BRIEF SUMMARY OF THE INVENTION

The present invention is directed to a novel purification process for cooking oil at or near the cooking apparatus wherein heated cooking oil moves from a fine mesh fryer basket substantially immersed in an oil reservoir or vat of the cooking apparatus through high temperature piping to a pump and a cartridge of Food and Drug Administration (FDA approved high temperature polymer to remove and trap solids suspended in cooking oil. The filtered cooking oil passes through high temperature piping back to the oil reservoir or vat. The fryer basket comprises a fine mesh wire screen in which food is fried when the basket is immersed in the cooking oil. The fine wire mesh acts a surface filter to segregate organic material suspended in the cooking oil contained in the oil reservoir. The cartridge of FDA approved high temperature polymer is placed within a high temperature filter housing which can be fixed above, below or at the same level as the positive displacement pump. Both the suction and discharge ends of purification system are located below the surface of the cooking oil contained within the reservoir or vat of the cooking apparatus.

The present invention of a cartridge form of filter media comprising food grade high temperature polyester eliminates the purification problems associated with loose form filter media and pre-coat filters. The cartridge filter form also reduces the time to replace filter media and the likelihood of contamination and loss of cooking oil. Finally, the cartridge form of filter media provides consistent and repeatable filter characteristics to be utilized or changed in the present novel cooking oil filtration system. Likewise, the use of the fine wire mesh fryer basket allows any type of pump (positive displacement or otherwise) to be used to continuously circulate the cooking oil at frying temperature through the filter.

### BRIEF DESCRIPTION OF THE SEVERAL VIEWS OF THE DRAWINGS

FIG. 1 is a schematic of the novel cooking oil filtration system 10 depicting a fryer basket 70 with a fine wire mesh 73 immersed in cooking oil 05 held in a cooking oil reservoir 03 of a cooking apparatus 01, a filter housing 11, pump 20, pump suction line 30, shut off valve 35, pump discharge line 40, Y-valve 45, return line 50, and discharge line 60. Organic contaminants 07 are suspended in cooking oil 05.

FIG. 2 is a overhead view of an embodiment of the filter housing 11.

FIG. 3 is a cross sectional plan view of an embodiment of the novel cooking oil filtration system 10 depicting the FDA approved high temperature polymer 15 in the form of yarn wound into a hollow cylindrical form about a foraminous core 17.

### DETAILED DESCRIPTION OF THE INVENTION

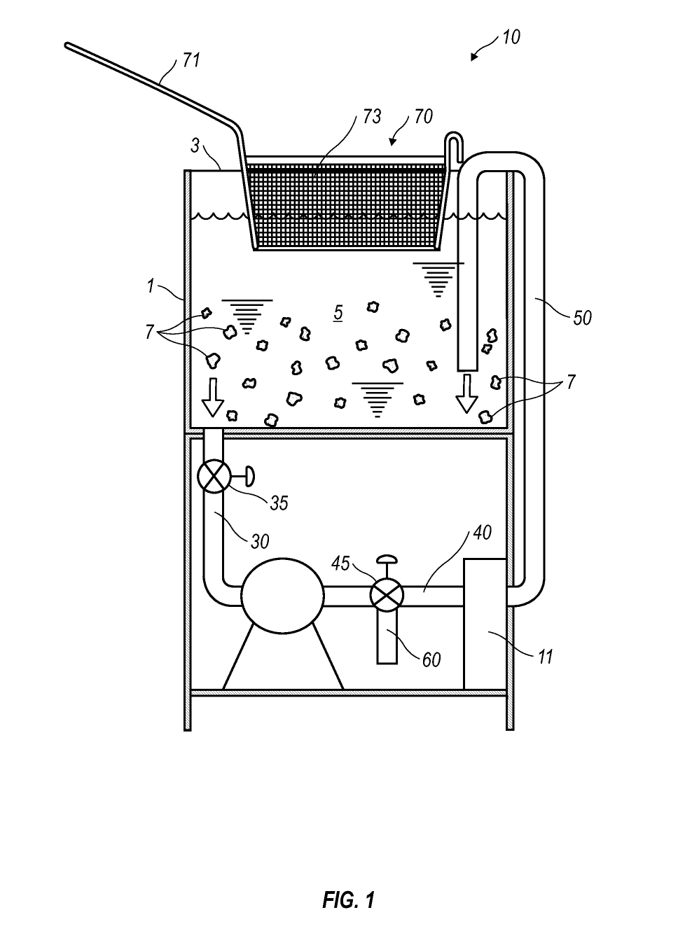

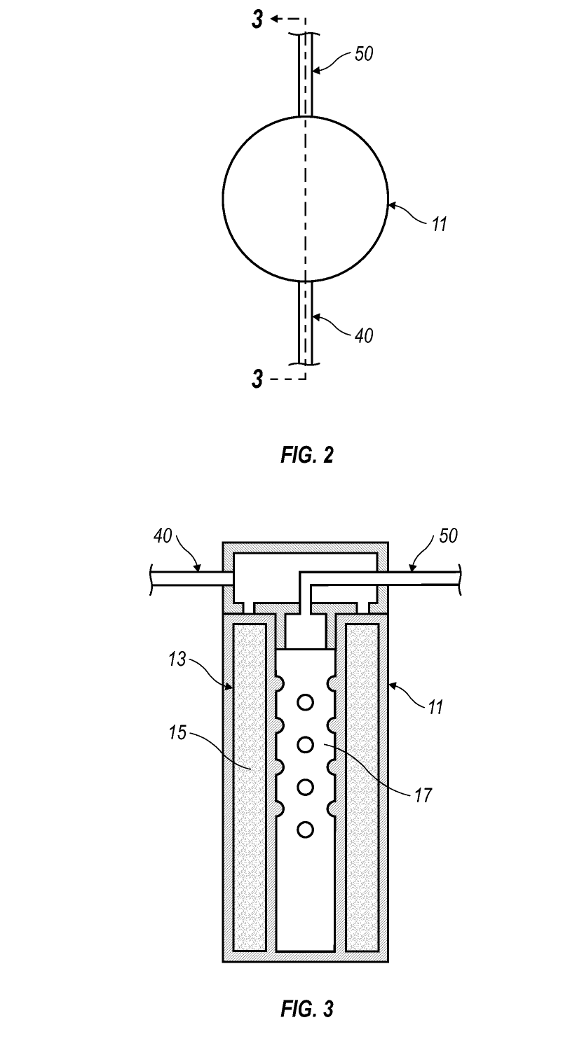

The present invention of a cooking oil filtration system 10 contemplates the use of a pump 20 fluidly connected by a pump suction line 30 to a cooking oil reservoir 03 of a cooking apparatus 01. See FIG. 1. In a preferred embodiment, the cooking apparatus 01 is a deep fat fryer. In another embodiment, the cooking apparatus 01 is a vacuum fryer. The cooking oil reservoir 03 holds a pre-determined volume of cooking oil, fat or lard 09. Food is placed within a fryer basket 70 and immersed in the heated cooking oil 09. The fry basket 70 comprises a fine wire mesh 73 with a mesh size ranging between approximately 50 to approximately 250 such that the micron rating is between approximately 360 microns to approximately 60 microns. Suspended in the cooking oil, fat or lard 09 are unwanted organic contaminants 07 which are the byproduct of frying food in the fryer basket 70. The unwanted organic contaminants 07 can be solids such breading, vegetable or meat as well as organic acids, such as free fatty acids, and organic alcohols suspended in the cooking oil, fat or lard 09. Any one or combination of the above listed organic contaminants 07 can alter the flavor and useful life of the cooking oil, fat or lard 09. It is the main purpose of this invention to remove or at least reduce the concentration of these organic contaminants 07 through the use of filtration while the cooking oil, fat or lard 09 is at a frying temperature but not to exceed 400 degrees Fahrenheit. The temperature of the cooking oil 05 is maintained by the cooking apparatus 01.

The fryer basket 70 comprises a handle 71 attached to a basket 73 with at least sides and a bottom made of fine wire mesh. While holding food, the fine wire mesh basket 73 is immersed in the cooking oil 05 which is at the desired cooking temperature. The fine wire mesh basket 73 acts a surface filter to at least reduce the spread of organic contaminants 07 from the food in the fine wire mesh basket 73 into the oil reservoir 03. The fryer basket 73 is constructed from fine wire mesh, preferably stainless steel, but can be any FDA approved material rated for use at high temperatures not to exceed 400 degrees Fahrenheit. It is contemplated that the wire mesh would be a mesh size between approximately 50 to approximately 250 such that the micron rating is between approximately 360 microns to approximately 60 microns. The fryer basket 70 described above used in conjunction with the filter described below, operates as a two stage cooking oil filtration system 10.

A pre-determined amount of food grade and/or FDA approved high temperature polymer material 15 is shaped into a hollow cylinder. See FIG. 3. In one embodiment, the food grade and/or FDA approved high temperature polymer material 15 is in the form of a yarn that is spun into the hollow cylinder shape. In another embodiment, the food grade and/or FDA approved high temperature polymer material 15 is in the form of a plurality of microfibers thermally bonded into a one piece cordless hollow cylinder shape. In either one of these embodiments, it is further contemplated as yet another embodiment, that the food grade and/or FDA approved high temperature polymer material is fixed to the exterior surface of a foraminous core 17. See FIG. 3. The porosity of the filter 15 can be varied at different depths within the food grade and/or FDA approved high temperature polymer material by changing the density of the yarn or the microfibers. Likewise, the porosity of the filter 15 can be varied by changing the movement and speed of the yarn as it is spun into the hollow cylinder shape or the heat required to thermally bond the plurality of microfibers into a one piece cordless hollow cylinder shape. Furthermore, these techniques can be combined to create filter 15 with a hybrid construction of thermal bonded microfibers and spun yarn food grade and/or FDA approved high temperature polymer material. Regardless of the construction method, filter 15 would range in length from approximately 10 inches to approximately 20 inches; outside diameter ranging from approximately 1 inch to approximately 4 inches; and inside diameter ranging from approximately 1 inch to approximately 2 inches.

The filter 15 is fixed within a cavity 13 formed within a filter housing 11. In a preferred embodiment, the filter housing 11 and cavity 13 are formed from stainless steel. In another embodiment, the filter housing 11 and cavity 13 are constructed from a pre-determined amount of food grade and/or FDA approved high temperature polymer material. The filter housing 11 can be re-sealable by traditional means known to those skilled in the art so that filter 15 can be replaced without the need of replacing the filter housing 11; otherwise both filter housing 11 and filter 15 must be replaced as a single unit. If filter 15 and filter housing 11 are consider a single unit, then in a preferred embodiment, food grade and/or FDA approved high temperature quick disconnect couplers known to those skilled in the art are used between the pump discharge line 40, return line 50 and filter housing 11.

The filter housing 11 can be fixed in any position from vertical to horizontal and any position in between. In a preferred embodiment, the filter housing 11 is fixed above the pump 20. In another embodiment, the filter housing 11 is fixed generally at the same elevation as the pump 20. And in yet another embodiment, the filter housing 11 is fixed at a position below the pump 20. Importantly, the end of the return line 50, submerged below the surface of the cooking oil, fat or lard 05 should not be above the highest point on the filter housing 11, unless a siphon break known to those in the art is fitted in the return line to prevent back siphoning when the filter housing 11 is opened or removed from the cooking oil filtration system 10.

It is contemplated that the lines which fluidly connect the various components of the cooking oil filtration system 10 can be constructed of any material that is of food grade and capable of withstanding high temperatures not exceeding 400 degrees Fahrenheit. In a preferred embodiment, pump suction line 30, pump discharge line 40, return line 50 and disposal line 60 are fabricated from stainless steel tubing used in the food industry. In another embodiment, these lines are fabricated from flexible tubing or hose used in the food industry with high temperatures.

The pump 20 used in the cooking oil filtration system 10 can be a rotary or reciprocating positive displacement pump or a centrifugal pump. In a preferred embodiment, the pump is a positive displacement pump 20. In another embodiment, the pump 20 is a centrifugal piston or diaphragm pump. It is contemplated that the pump 20 can be mounted above, below or generally at the same level as the surface level of the cooking oil 05 within the cooking oil reservoir 03. In a preferred embodiment, the pump 20 must be of sufficient capacity to produce at least 20 psi. It is contemplated that the operation of the pump 20 would be handled through conventional control means known to those skilled in the art, such a manual control on/off switch or an automated control system based on well known temperature and pressure sensors. Regardless of the control means, the present invention contemplates continuous filtration while the cooking oil 05 is at cooking temperature.

Although the present invention and its advantages have been described in detail, it should be understood that various changes, substitutions and alterations can be made herein without departing from the spirit and scope of the invention as defined by the claims set forth below.

I claim:

1. A high temperature cooking oil purification system comprising:
a pump with a pump suction inlet and a pump discharge outlet, wherein a pump suction line is fluidly connected between a cooking oil reservoir filled with cooking oil and said pump suction inlet, wherein organic contaminants are suspended in said cooking oil;
a pre-determined amount of FDA approved high temperature polymer material shaped into a filter with a hollow cylinder shape, said filter fixed within a cavity formed within a filter housing, wherein opposing ends of said hollow cylinder are fluidly sealed against opposing ends of said cavity to form an annular chamber between an exterior surface of said filter and an interior surface of said cavity;
a pump discharge line fluidly connected between said annular chamber and said pump discharge outlet; and
a return line fluidly connected between said filter and said oil reservoir, wherein said organic contaminants and said cooking oil are sucked from said oil reservoir through said pump suction line through said pump suction inlet into said pump and discharged under pressure from said pump discharge outlet through said pump discharge line into said annular chamber and across said FDA approved high temperature polymer material, trapping at least some of said organic contaminants as said cooking oil passes into said hollow cylinder and thereafter said cooking oil is discharged into said oil reservoir through said return line.

2. A high temperature cooking oil purification system as claimed in claim 1, wherein said FDA approved high temperature polymer material is in the form of yarn spun into said hollow cylinder shape.

3. A high temperature cooking oil purification system as claimed in claim 2, wherein the density of said yarn is varied to alter the porosity of said filter at different depths within said FDA approved high temperature polymer material.

4. A high temperature cooking oil purification system as claimed in claim 2, wherein said spinning is varied to alter the porosity of said filter at different depths within said FDA approved high temperature polymer material.

5. A high temperature cooking oil purification system as claimed in claim 1, wherein said filter housing is re-sealable to allow the replacement of said filter.

6. A high temperature cooking oil purification system as claimed in claim 1, wherein said filter comprises FDA approved high temperature polymer microfibers thermally bonded into a one piece cordless construction having said hollow cylinder shape.

7. A high temperature cooking oil purification system as claimed in claim 1, wherein a shut off valve is positioned between said oil reservoir and said pump suction line to block the flow of said solids and said cooking oil to said positive displacement pump.

8. A high temperature cooking oil purification system as claimed in claim 1, wherein a Y-valve is positioned in said pump discharge line to selectively connect to said annular cavity or a disposal line.

9. A high temperature cooking oil purification system as claimed in claim 1, wherein said pump suction line draws said solids and cooking oil from below a surface of said cooking oil within said reservoir.

10. A high temperature cooking oil purification system as claimed in claim 1, wherein said return line discharges said cooking oil below a surface of said cooking oil within said reservoir.

11. A high temperature cooking oil purification system as claimed in claim 1, wherein a fryer basket, constructed of fine wire mesh, holds food and is immersed in the cooking oil to fry said food, wherein said fryer basket at least reduces migration of organic contaminants into said cooking oil.
